(19) United States
(12) Patent Application Publication
(10) Pub. No.: US 2008/0116019 A1
(43) Pub. Date: May 22, 2008

(54) BRAKE RUNNING CLEARANCE ADJUSTMENT DEVICE

(76) Inventor: Thomas Hung Vu, Cedar Falls, IA (US)

Correspondence Address: DEERE & COMPANY, ONE JOHN DEERE PLACE, MOLINE, IL, 61265, US

(21) Appl. No.: 11/561,139

(22) Filed: Nov. 17, 2006

(51) Int. Cl. F16D 55/22; F16D 55/36

(52) U.S. Cl. 188/71.5; 188/72.1

(57) ABSTRACT

A brake assembly for a vehicle, such as an agricultural vehicle, having a brake housing and a brake cover defining a friction chamber. A brake piston is arranged within the friction chamber and coupled to the brake cover by at least one bolt having a sleeve in frictional engagement with a bore of the brake piston. The sleeve has a slip fit engagement with a bolt head and further includes a shoulder opposed to a retainer being axially spaced therefrom by a distance exceeding an axial height of the bolt head by an amount equal to an optimal running clearance. An actuation system is coupled to apply an axial force to the brake piston, the axial force being greater than the frictional fit of the sleeve to the bore in order to adjust a running clearance of the brake assembly to equal the optimal running clearance.

### BACKGROUND

1. Field of the Invention

The present invention generally relates to a brake assembly for a motor vehicle. More specifically, it relates to a device that provides running clearances in the brake disks used in the brake assembly of an agricultural vehicle, such as a tractor.

2. Description of Related Technology

Brake assemblies are generally used to stop the movement of motor vehicles, such as an agricultural tractor. As shown in U.S. Pat. No. 6,002,976, the driveline of a typical agricultural tractor, for example a tractor in the John Deere 6000 series, includes an engine, a shifted multi-speed transmission, a reversing unit, a drive clutch, an optional creeper transmission, a shifted range transmission, and a rear axle differential gear which the drives the rear wheels. As shown in U.S. Pat. No. 5,197,574, a brake may also be provided between the transmission housing and the rear axle differential gear. Due to the low operating speeds, large mass and high torque under which agricultural tractors operate, these brakes are often configured so the brake disks are submerged in oil. The oil serves to lubricate and carry heat away from the brake disks when the brakes are applied by a tractor operator.

When the brakes are initially assembled, an optimal running clearance is set between a brake piston, the brake disks, separator plates (if applicable) and a brake cover. The optimal running clearance is carefully calibrated, depending on the geometry of a particular application, to minimize the response time and pedal throw required to engage the brake piston against the brake disks, while also minimizing the effects of windage (the frictional force acting on the oil caused by the relative motion of the brake disks to the brake piston separator plates and cover).

Ideally, a very small running clearance is desired to allow for fast brake engagement and a short pedal throw. However, if the clearance is too small, windage effects may prevent sufficient oil flow between the braking surfaces, interfering with the lubrication and cooling of the brake disks. In addition, the small amount of oil between the braking surfaces may become entrapped. As a result, even when the brake is not engaged, significant heat may be generated between the braking surfaces and the entrapped oil, causing damage to the brake assembly.

Once the optimal clearance has been established for a particular application, it is desirable to maintain that clearance over the lifetime of the components. However, as the brakes are applied during operation of the tractor, the braking surfaces of the brake disks, brake piston, brake cover and separator plates (if applicable) experience wear. After a number of hours of operation, which varies from application to application, the wear may result in an actual running clearance significantly greater than the optimal clearance. This has the undesirable effect of increasing both the response time and pedal throw of the brake assembly. Currently, any increased running clearance is periodically compensated for by manually adjusting the brake assembly. This is a time consuming process, however, and increases the maintenance costs of the vehicle. In addition, there is the risk that the running clearance may be incorrectly adjusted.

In view of the above, it is apparent that there exists a need for a brake assembly for a motor vehicle that that automatically adjusts the running clearance of the brake discs to compensate for wear of the braking surfaces.

### SUMMARY

In satisfying the above need, as well as overcoming the enumerated drawbacks and other limitations of the related art, the present invention provides a brake assembly that maintains an optimal running clearance between braking surfaces of the assembly, without the need for periodic manual adjustment. This is accomplished by providing at least one bolt includes a sleeve coaxially installed with a slip fit around a head of the bolt. A spring, bearing against the brake cover, acts to bias the sleeve against a shoulder of the bolt head and acts to return a brake piston to a start position when the brake is disengaged. The sleeve is installed using a frictional press fit within a bore in the brake piston. The brake piston is actuated hydraulically by pressurized brake fluid applied against a brake piston area. The pressurized brake fluid causes the piston assembly to move axially, closing the running clearance, and engaging the braking surfaces of the assembly.

When the brake is engaged the sleeve translates with the brake piston and the bolt head slides within the sleeve a distance equal to the running clearance of the brake assembly. When the actual running clearance is equal to the optimal running clearance, the bolt head will just come into contact with a retainer ring as the brake piston engages the braking surfaces. If the running clearance exceeds the optimal running clearance, the bolt head will contact the retainer before the piston engages the braking surfaces. In this case, the sleeve stops moving while the hydraulic fluid continues to move the brake piston. Since the hydraulic force exceeds the frictional fit of the sleeve, the sleeve will slip slightly within the bore and compensate for the increased running clearance by repositioning the brake piston so the actual running clearance equals the optimal running clearance.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a partial cross-sectional view of a brake assembly, having a single brake disk, along a centerline of a shaft;

FIG. 2 is a brake assembly, similar to that of FIG. 1, having dual brake disks;

FIG. 3 is an enlarged view, of the portion generally enclosed by circle 3 in FIG. 2, showing the brake assembly in a disengaged state of operation; and

FIG. 4 is an enlarged view, of the portion generally enclosed by circle 3 in FIG. 2, showing the brake assembly in an engaged state of operation.

### DETAILED DESCRIPTION

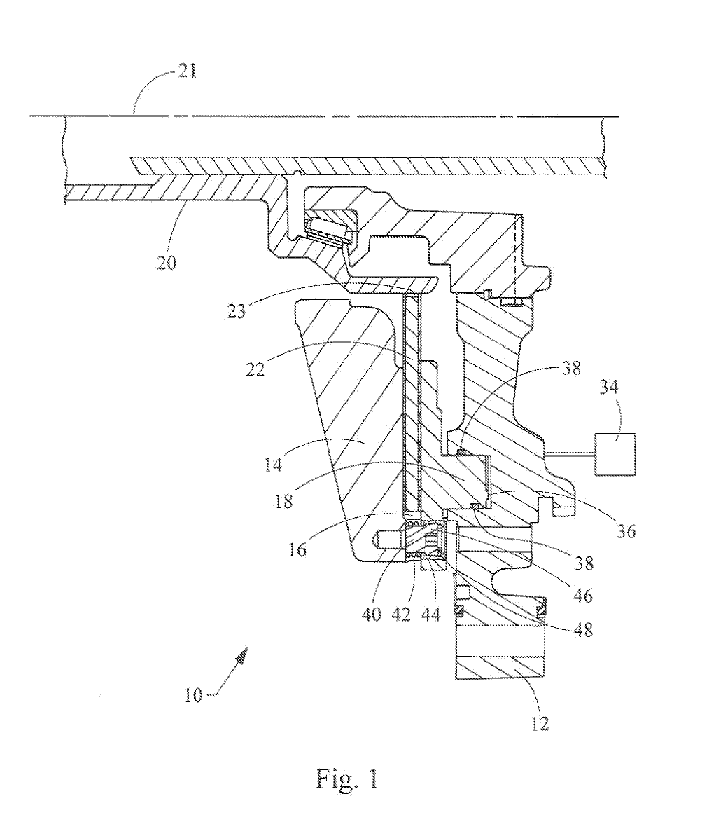

Referring now to the drawings, FIG. 1 shows a brake assembly designated at 10, generally embodying the principles of the present invention. As its primary components, the brake assembly 10 includes a brake housing 12 and a brake cover 14 defining a friction chamber 16. A brake piston 18 is arranged within the friction chamber 16 and movably connected to the brake housing 12 and the brake cover 14. Fixedly coupled to a rotating shaft 20 of the vehicle (not shown) is at least one brake disk 22, located within the friction chamber 16 between the brake piston 18 and the brake cover 14. Activation of an actuation system 34 moves the brake piston 18 axially, generally parallel to a center line 21 of the shaft 20, closing the running clearances 24 on each side of the brake disk 22 and resulting in frictional engagement of the rotating brake disk 22 between the brake piston 18 and the brake cover 14.

The actuation system 34 may be any conventional system including, but not limited to, hydraulic, pneumatic, or electrical systems. The present embodiment presumes a hydraulic system. When the actuation system 34 is activated, for example by an operator depressing a brake pedal (not shown), pressurized hydraulic fluid is provided to a brake piston area 36. The fluid is contained within the brake piston area 36 by o-rings 38 and applies a brake engagement force to the brake piston 18 causing it to move axially and engage the brake disk 22. When the actuation system 34 is deactivated, the hydraulic fluid is depressurized and at least one spring 42 returns the brake piston 18 to its initial position, disengaging it from the brake disk 22.

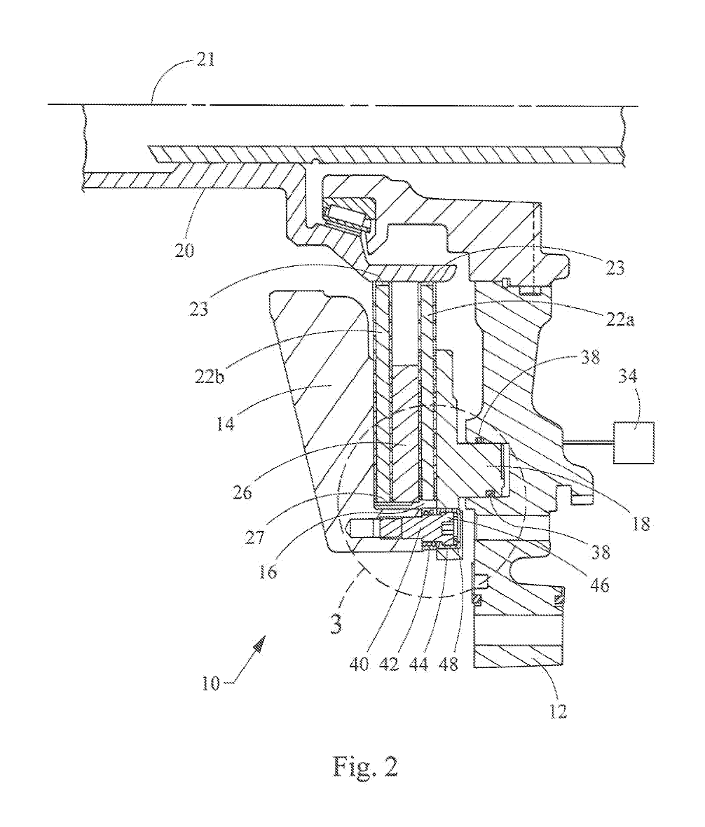

FIG. 2 illustrates a second embodiment including a separator plate 26 in the friction chamber 16 located between two brake disks 22. Separator plates 26 are only necessary for those embodiments including more than one brake disk 22, and the number of separator plates 26 for a particular embodiment is one less than the number of brake disks 22. The separator plate 26 is attached to the brake cover 14 by a connection 27 configured to prevent rotation of the separator plate 26 while still permitting axial movement. In the example shown in FIG. 2, the connection 27 includes tabs attached to the separator plate 26 and slideably engaged with slots (not shown) in the brake cover 14. This has the advantage of being simple to fabricate and low in cost. In another example, a radial spline (not shown) on the outer diameter of the separator plate 26 engaging a mating spline on the inner diameter of the brake cover 14. While a spline may result in a more durable connection 27, it is also more costly and difficult to manufacture than other arrangements.

The brake disk 22 may be coupled to the rotating shaft 20 by means of a disk spline 23, or a similar arrangement, that allows the brake disk 22 to float axially along the shaft while still transferring torque between the disk 22 and the shaft 20. In the present example, the rotating shaft 20 is further coupled to wheels of the motor vehicle (not shown) by, for example, a differential and to an engine by, for example, a transmission. When the vehicle (not shown) is in operation, the brake disk 22, being coupled to the rotating shaft 20, rotate within the friction chamber 16. Stopping the rotation of the brake disk 22 stops rotation of the shaft 20 and, accordingly, stops rotation of the wheels and brings the vehicle to a halt. This is but one exemplary use of the brake assembly 10. Another example may locate two brake assemblies 10 between the differential and the wheels.

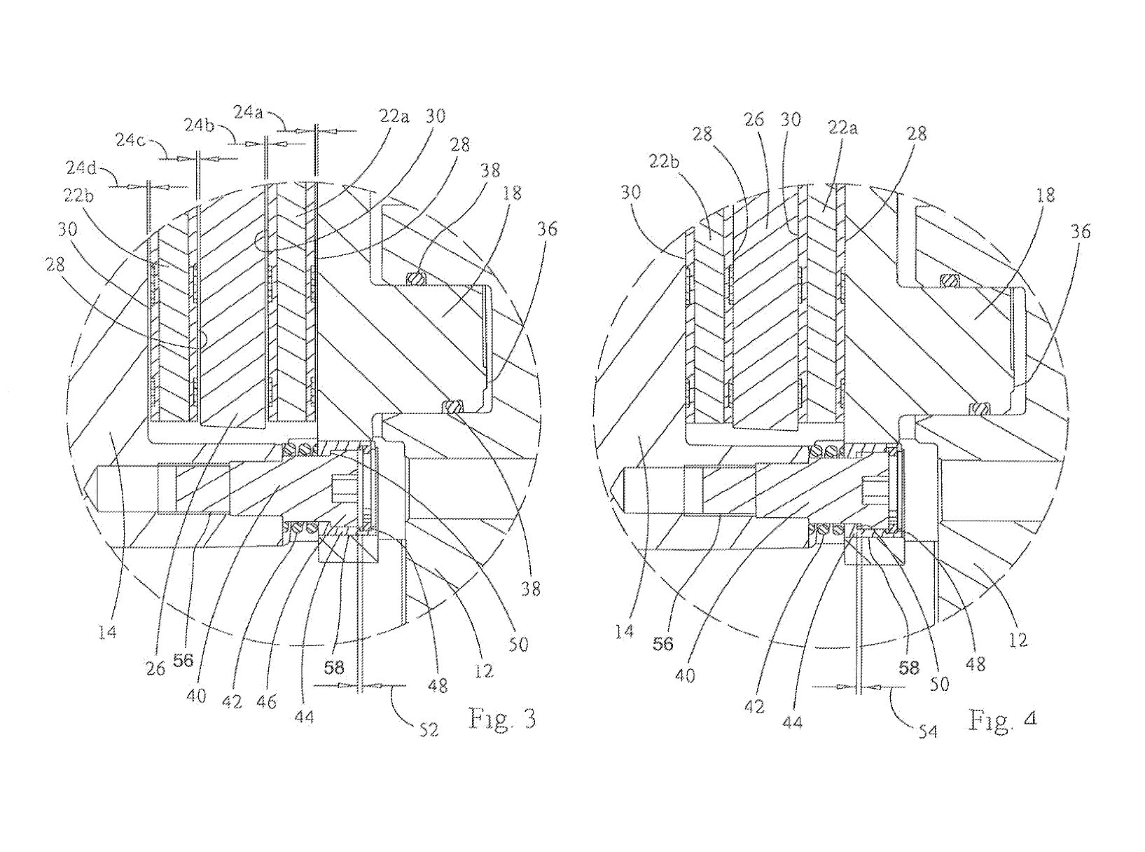

Turning to FIG. 3, the rotating brake disks 22 are stopped by applying a frictional braking force to first and second braking surfaces 28 and 30 and of the brake disks 22. The frictional force is applied by clamping the brake disks 22 between the brake piston 18, the brake cover 14, and (if applicable) the separator plate 26. The application of friction generally turns kinetic energy of the rotating shaft 20 into heat, which may be dissipated away from the brake disks 22 by any appropriate means. While some brake assemblies may use air to cool the brake disks 22, the present embodiment submerges the brake disks 22 in oil. This provides both cooling and lubrication to the brake assembly 10 and is particularly appropriate for use with agricultural tractors.

Referring to FIG. 3, the clamping of the brake disks 22 is done by moving the brake piston 18 over a running clearance 24a into contact with a first braking surface 28 of the rotating brake disk 22a. Upon contacting the first braking surface 28, the brake disk 22a is moved by the brake piston 18, a distance equal to a running clearance 24b until the second braking surface 30 comes into contact with the separator plate 26. The separator plate 26 then moves, along with the brake disk 22a and brake piston 18, a distance corresponding to a running clearance 24c, bringing the separator plate 26 into contact with the first braking surface 28 of a brake disk 22b. The brake piston 18, and the other components described above, only stop moving once the second braking surface 30 of the brake disk 22b closes a final running clearance 24d and contacts the brake cover 14 (see FIG. 4).

While the above description is one embodiment, the number of brake disks 22 may vary significantly between applications. Depending on the weight and performance of a particular tractor it may have as few as one brake disk 22 (see FIG. 1) or more than two (not shown) without departing from the spirit of the present invention.

The actual running clearance of the brake assembly 10 equals the distance the brake piston 18 must travel in order to clamp the brake disks 22 equal to the sum of the running clearances 24a, 24b, 24c, and 24d. (See FIGS. 3 and 4.)

The brake piston 18 is coupled to the brake cover 14 by at least one bolt 40, with an exemplary embodiment using three bolts 40. As best shown in FIG. 3 or 4, the bolt 40 is received within the spring 42 and a sleeve 44 coaxially arranged around the bolt. The sleeve 44 is slip fit around a head 46 of the bolt 44 and is retained around the bolt head 46 by a retainer 48 and a shoulder 50, the latter preferably being formed in the sleeve 44 itself but it may also include a separate component. A threaded end 56 of the bolt 40 is engaged with the brake cover 14 and, as a result, the spring 42 is compressed between the brake cover 14 and the sleeve 44. The brake piston 18 is coupled to the bolt 40 by means of a frictional (i.e. press) fit between an outer diameter of the sleeve 44 and an inner diameter of a bore 58 formed in the brake piston 18.

The sleeve 44 is dimensioned to be substantially restrained from radial movement around the bolt head 46, while permitting axial motion along the length of the bolt 40. The amount of axial motion is determined by the axial separation between the retainer 48 and the shoulder 50, wherein the axial separation exceeds the axial height of the bolt head 46 by an amount equal to an optimal running clearance, as reflected by a gap 52 shown in FIG. 3.

The optimal running clearance is calculated based on various factors including the number of brake disks 22, separator plates 26, the required response time of the brake assembly 10, the brake pedal throw (not shown) of the actuation system 34 and the cooling requirements for a particular application. Since most applications desire a quick response time and a short pedal throw, it is desirable for the gap 52 to be as small as possible. However, at a certain point gap 52 will be too small and incidental contact may result between the brake disks 22, brake cover 14, brake piston 18, and the separator plates 26 when the brake is not engaged due to the tolerance stack up between these components. In addition, windage effects may generate additional heat and prevent sufficient cooling oil from flowing between the brake disks 22. These factors may cause damage to brake assemblies 10 having very small running clearances 24. Thus, the optimal running clearance is calculated to eliminate the risk of damage, while still keeping the response time and pedal throw to a minimum.

In a brake assembly 10 experiencing little or no wear, the gap 52 equals the actual running clearance and the brake piston 18 will fully engage the brake disks 22, stopping their rotation. On the other hand, when the braking surfaces 28 and 30 of the brake disks 22, along with the opposing surfaces of the brake cover 14, the brake piston 18 and separator plates 26, experience wear from operation, the running clearances 24 will increase. This undesirably increases the response time and pedal throw required to engage the brake assembly 10.

As constructed, the frictional fit between the sleeve 44 and the brake piston 18 allows the brake assembly 10 to compensate for such wear. As can be seen in FIG. 4, when the brake assembly is engaged, a second gap 54 opens between the shoulder 50 and the bolt head 46 while the gap 52 closes. When the actual running clearance is greater than the gap 52, the bolt head 46 will come into contact against the retainer 48 before the brake assembly 10 is engaged, preventing further motion of the sleeve 44. The actuation system 34, however, is configured to continue to apply axial force to the brake piston 18 that exceeds the frictional fit of the sleeve 44 to the bore 58. As a result, the sleeve 44 will slip within the bore 58 until the brake piston 18 fully engages the brake disks 22. Upon release of the actuator system 34, the sleeve 44 stays in its new position, resetting the axial position of the brake piston 18 to compensate for the above mentioned wear. Finally, the spring 42 acts against the sleeve 44 to return the brake piston 18 to its disengaged position, closing the second gap 54 while opening the first gap 52. The actual running clearance then again corresponds with the optimal running clearance corresponding to the gaps 52 and 54.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

What is claimed is:

1. A brake assembly for a vehicle such as an agricultural vehicle, the brake assembly comprising:
a brake housing and a brake cover defining a friction chamber;
a brake piston being arranged within the friction chamber and coupled to the brake cover by at least one bolt, the bolt including a first end attached to the cover and a second end coupled to the brake piston by a sleeve in frictional engagement with a bore defined in the brake piston, the sleeve being in slip fit engagement with the second end of the at least one bolt;
the sleeve further including a shoulder opposed to a retainer and being axially spaced therefrom by a distance exceeding an axial height of a bolt head on the second end of the bolt, the distance exceeding an axial height of the bolt head by an amount equal to an optimal running clearance; and
the sleeve being configured for axial movement with respect to the bolt head, the movement being limited to the optimal running clearance; and
an actuation system coupled to apply an axial force to the brake piston, the axial force being greater than the frictional fit of the sleeve with the bore; and
at least one brake disk having braking surfaces is provided within the friction chamber between the brake piston and the brake cover; and
wherein engagement of the actuation system results in axial movement of the brake piston until the braking surfaces of the brake disk engage the brake piston and brake cover.

2. The brake assembly of claim 1 including at least two brake disks and at least one separator plate arranged between the at least two brake disks.

3. The brake assembly of claim 1 further comprising at least one spring arranged coaxially around the at least one bolt and located between the sleeve and the brake cover, the spring biasing the shoulder against the bolt head.

4. The brake assembly of claim 1 wherein running clearances are defined between the braking surfaces, the brake piston, and the brake cover when the actuation system is disengaged, the sum of the running clearances being equal to the optimal running clearance.

5. The brake assembly of claim 4 whereby when the sum of the running clearances exceeds the optimal running clearance, engagement of the actuation system causes the bolt head to contact the retainer while the axial force continues to move the brake piston causing the sleeve to move axially within the bore until the braking surfaces contact the brake piston and brake cover.

6. The brake assembly of claim 2 wherein the separator plate is coupled to the brake cover by a spline to prevent rotation of the separator plate relative thereto.

7. The brake assembly of claim 2 wherein the separator plate is coupled to the brake cover by at least one tab to prevent rotation of the separator plate relative thereto.

8. The brake assembly of claim 1 wherein the brake piston is coupled to the brake cover by three bolts.

9. The brake assembly of claim 1 wherein the friction chamber is filled with oil.

10. The brake assembly of claim 1 wherein the brake assembly is coupled to a drive shaft of the motor vehicle and is arranged between a transmission and a differential of the vehicle.

11. The brake assembly of claim 1 wherein the brake assembly is coupled to a drive shaft of the motor vehicle and is arranged between a wheel and a differential of the motor vehicle.
